(19) United States
(12) Patent Application Publication
(10) Pub. No.: US 2016/0258589 A1
(43) Pub. Date: Sep. 8, 2016

(54) LASER OPTICAL SYSTEM FOR VEHICLE LAMP

(71) Applicant: Hyundai Motor Company, Seoul (KR)

(72) Inventor: Byoung Suk AHN, Suwon-si (KR)

(73) Assignee: Hyundai Motor Company, Seoul (KR)

(21) Appl. No.: 14/806,994

(22) Filed: Jul. 23, 2015

(30) Foreign Application Priority Data
Mar. 5, 2015 (KR) 10-2015-0030931

(51) Int. Cl. F21S 8/10

(52) U.S. Cl. CPC F21S 48/1388; F21S 48/1109; F21S 48/328; F21S 48/1323; F21S 48/1394; F21S 48/125; F21Y 2101/025

(57) ABSTRACT

A laser optical system for a vehicle lamp may include a plurality of light sources for generating laser beams, a Printed Circuit Board (PCB) fixed and connected to the light sources and configured to control supply of current to the light sources, a light emitting section for acting with light output from the light sources and outputting white light, a plurality of reflectors for reflecting the light output from the light sources to the light emitting section, and a housing to which the PCB and the light emitting section are fixed and connected, in which the light sources and the light emitting section are connected to the housing in such a way that a laser beam projecting direction and a white light projecting direction are opposite, and an interior side of the housing facing the laser beam projecting direction is the reflector.

### CROSS-REFERENCE TO RELATED APPLICATION

The present application claims priority to Korean Patent Application Number 10-2015-0030931 filed Mar. 5, 2015, the entire contents of which is incorporated herein for all purposes by this reference.

### BACKGROUND OF THE INVENTION

1. Field of the Invention

The present invention relates to a laser optical system for a vehicle lamp. More particularly, it relates to the laser optical system for a vehicle lamp in which a plurality of light sources are collected into one light emitting section, thereby securing an amount of the light through the increase of the excited light and reducing the size of an optical system.

2. Description of Related Art

A head lamp of a vehicle is a device for illuminating a front of the vehicle for securing a front side visibility, and usually a halogen, High intensity discharge (HID), or LED diode is used for an light source, and recently, a head lamp in which a laser diode which is environmentally friendly, has an extended life, and has a high light efficiency is used as the light source has been developed, and in particular, a technology in which a plurality of light sources are used for securing an amount of the light through the increase of the excited light has been developed.

The conventional laser optical system using a plurality of light sources may include, as shown in FIG. 1, a plurality of light sources 1, an aspheric lens 2 for collecting the light projected from the light sources 1, a light guide section 3 (optical fiber) for transmitting the light of the light sources 1 collected through the aspheric lens 2, a light emitting section 4 for responding to the light of the light sources 1 transmitted through the light guide section 3 and outputting a fluorescent light, and a reflector 5 for reflecting back toward the light emitting section 4 the light which is incident to the light emitting section 4 and thereafter dispersed backwards.

The light sources 1 are laser diodes which generate the laser beam of the blue wave length, and the light emitting section 4 is a fluorescent body for acting with the light output from the laser diode and outputting the white light.

However, in the conventional laser optical system described above, the light sources 1 are placed outside of a housing 6 and the reflector 5 including the light emitting section 4 is placed inside of the housing 6 in such a way that the housing 6 is placed between them, so that there is disadvantage in that the light guide section 3 which is a light transmission medium is used to transmit the light of the light sources 1 to the light emitting section 4, whereby the cost is increased, and in particular, as the size of the entire optical system is increased, the weight and the cost are increased.

Reference numeral 7 not described above is a transparent plate through which the white light is output.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a laser optical system for a vehicle lamp in which a plurality of light sources are installed to be fixed in a housing and the housing itself is composed to act as a reflector, so that the light guide section which is a light transmitting medium is not used, whereby the saving of the cost, the reduction of the size of the entire optical system, and the reduction of the weight may be sought.

According to various aspects of the present invention, a laser optical system for a vehicle lamp may include a plurality of light sources for generating laser beams, a Printed Circuit Board (PCB) which is fixed and connected to the light sources and configured to control supply of current to the light sources, a light emitting section for acting with light output from the light sources and outputting white light, a plurality of reflectors for reflecting the light output from the light sources to the light emitting section, and a housing to which the PCB and the light emitting section are fixed and connected, in which the light sources and the light emitting section may be connected to the housing in such a way that a laser beam projecting direction and a white light projecting direction are opposite to each other, and an interior side of the housing facing the laser beam projecting direction may be the reflector.

The laser optical system for the vehicle lamp may further include a heat sink radiating heat generated at the light sources and the light emitting section to an outside.

The heat sink may be one in number, and heat from the plurality of light sources and the light emitting section may be radiated by the heat sink.

The light emitting section may be one in number, and the light emitting section may be placed at a center of the plurality of light sources.

The plurality of light sources may be arranged with equal spacing along a circumferential direction in which the light emitting section may be in the center, so as to be arranged cross to each other about the light emitting section.

The plurality of reflectors may be equal in number to the light sources, and the light sources and the reflectors may match with each other one to one.

A center of an incident plane of the light emitting section and a focal point of the reflectors may coincide.

Each reflector may form an ellipse having as focal points a center of a projecting plane of the light source which matches with the corresponding reflector and a center of an incident plane of the light emitting section, and may form a regular circle about an axis passing through the centers.

A surface of each reflector may be deposited with aluminum superior in reflection performance or treated with silver reflection coating to increase reflection efficiency.

The housing may include a lower cover in which an upper side thereof may be opened and an interior bottom side may be the reflector, and an upper cover, which may be connected to the lower cover so as to seal the upper opened side of the lower cover, the PCB being connected to an interior side of the upper cover so that the light sources face the reflector, the light emitting section being connected to the upper cover, and the heat sink being formed at an exterior side of the upper cover.

The laser optical system for the vehicle lamp may further include a light collecting lens which may be fixed to the lower cover so as to be placed at a front side of each light source, so as to collect light projected from the light sources.

The laser optical system for the vehicle lamp may further include an auxiliary reflector which may be connected to an outside surface of the upper cover so as to be placed at an outside of the housing and reflect back the white light projected through the light emitting section to a required direction.

The auxiliary reflector may be a parabolic reflection surface having as a focal point a center of a projection surface of the light emitting section or a rectangular projector.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a drawing of a conventional laser optical system for a vehicle lamp.

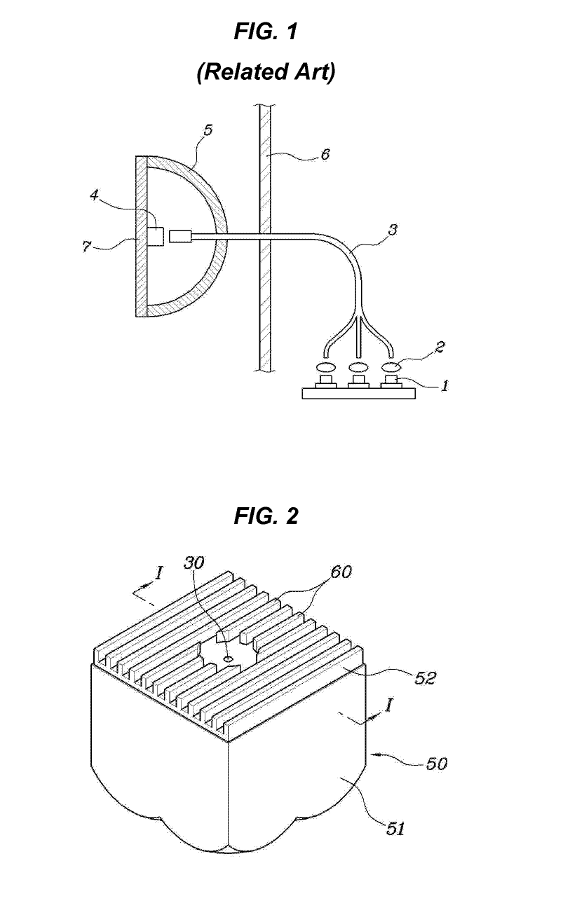

FIG. 2 is a perspective view of an exemplary laser optical system for a vehicle lamp according to the present invention.

FIG. 3 is an exploded perspective view of FIG. 2.

FIG. 4 and FIG. 5 are drawings illustrating a configuration of arrangement of light sources according to the present invention.

FIG. 6A, FIG. 6B and FIG. 7 are drawings illustrating a reflector according to the present invention, where FIG. 6A and FIG. 6B are a sectional view taken along the line I-I of FIG. 2 and FIG. 7 is a sectional view taken along the line II-II of FIG. 6A; and

FIG. 8 and FIG. 9 are drawings illustrating an auxiliary reflector according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

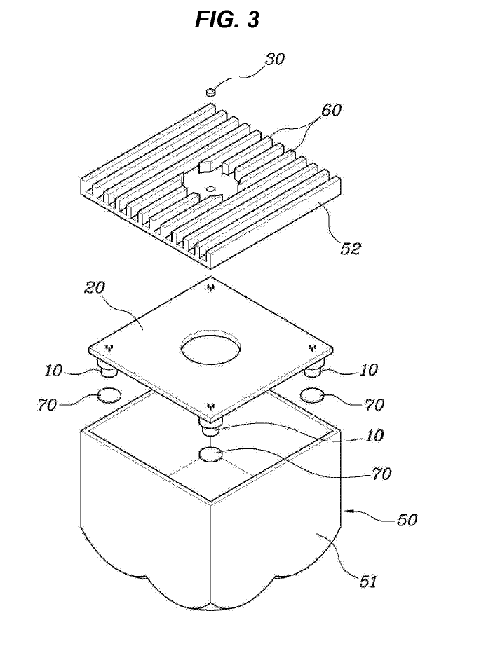

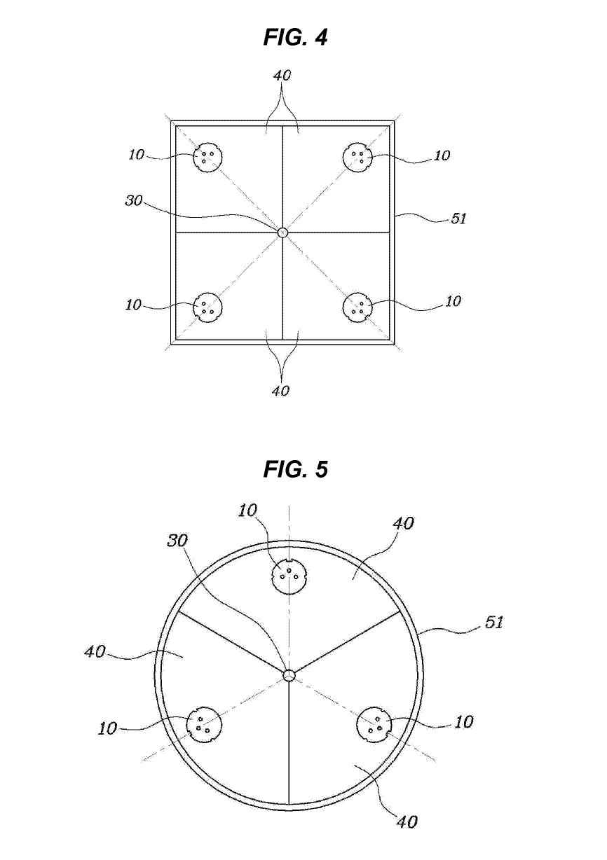

The laser optical system for a vehicle lamp according to the present invention includes a plurality of light sources 10 for generating the laser beams as shown in FIG. 2 to FIG. 9, a PCB 20 which is fixed and connected to the light sources 10 and controls the supply of current to the light sources 10, a light emitting section 30 for acting with the light output from the light sources 10 and outputting the white light, a plurality of reflectors 40 for reflecting the light output from the light sources 10 to the light emitting section 30, and a housing 50 to which the PCB 20 and the light emitting section 30 are fixed and connected.

The light sources 10 are a laser diode generating the laser beam of the band of blue wave length, and the light emitting section 30 is a fluorescent body acting with the light output from the laser diode and outputting the white light.

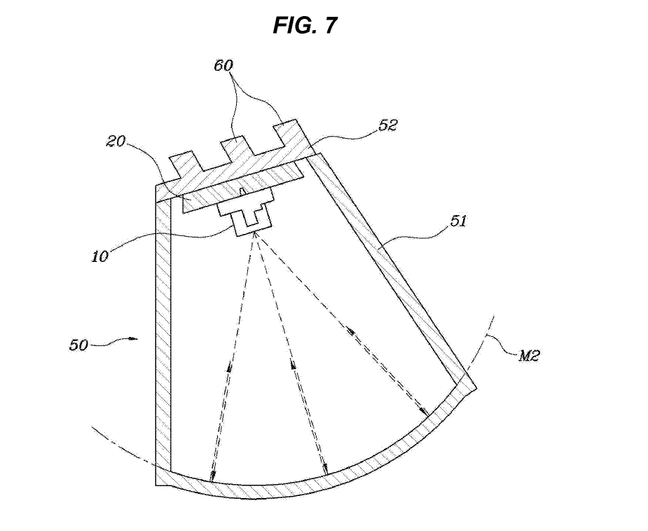

The light sources 10 and the light emitting section 30 according to the present invention are connected to the housing 50 in such a way that the laser beam projecting direction (A1, refer to FIG. 6A) and the white light projecting direction (B1; refer to FIG. 6A) are opposed to each other.

In addition, the interior side of the housing 50 facing the laser beam projecting direction A1 becomes the reflector 40.

Therefore, in the laser optical system for a vehicle lamp according to the present invention, the light of the plurality of light sources 10 is collected and output by one light emitting section 30, so that a large amount of the light may be secured through the increase of the excited light so as to significantly increase the light efficiency.

Furthermore, since the light sources 10, the light emitting section 30, and the reflector 40 are all provided in the housing 50, the size of the entire optical system may be reduced.

In particular, in the present invention, since the light guide section (optical fiber) which is a conventional light transmitting medium is not used, there are advantages in that the saving of the cost and the reduction of the weight may be sought and the size of the entire optical system may be reduced.

In addition, in the present invention, since a conventionally separate aspheric lens (light collection lens) is not used to collect the light output from the light sources 10, the saving of the cost and the reduction of the weight may be sought.

The present invention further comprises a heat sink 60 radiating the heat generated at the light sources 10 and the light emitting section 30 to the outside.

Due to the heat sink 60, the extension of life and the durability of the light sources 10, PCB 20, and the light emitting section 30 are improved.

The heat sink 60 is one in number and the heat from the plurality of light sources 10 and the light emitting section 30 is released by the one heat sink 60, whereby the cost may be reduced, the layout may be reduced, and the size of the optical system may be reduced.

Since the one light emitting section 30 is placed at the center of the plurality of light sources 10, the amount of light may be secured to the maximum.

In the construction in which the one light emitting section 30 is placed at the center of the plurality of light sources 10, the plurality of light sources 10 are arranged with equal spacing along the circumferential direction in which the light emitting section 30 is the center, so as to be arranged cross to each other about the light emitting section 30 taking the property of the semiconductor diode into consideration.

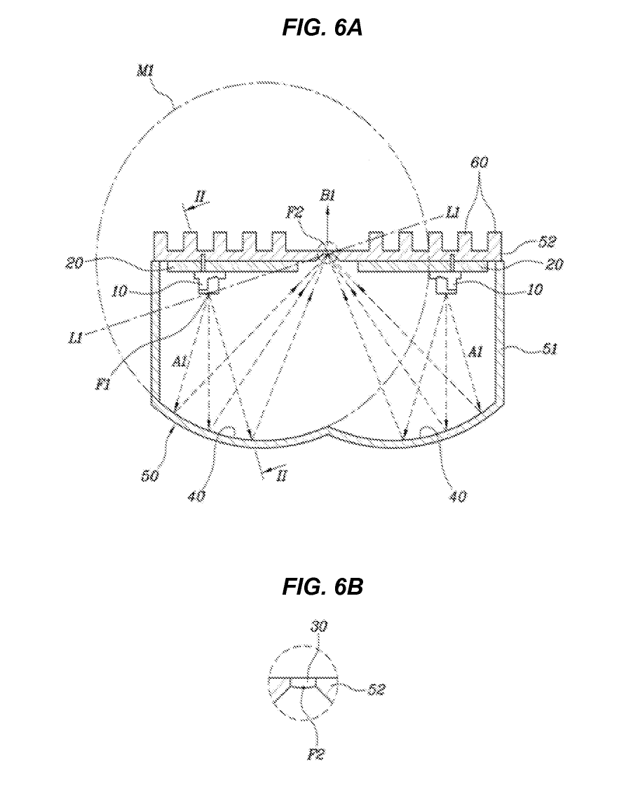

As an example, in the case where there are four light sources 10 as shown in FIG. 4, the four light sources 10 are arranged with the spacing of 90 degree along the circumferential direction in which the light emitting section 30 is the center, and in the case where there are three light sources 10 as shown in FIG. 5, the three light sources 10 are arranged with the spacing of 120 degree along the circumferential direction in which the light emitting section 30 is the center.

The plurality of reflectors 40 are composed in equal number as the light sources 10, and the light sources 10 and the reflectors 40 are matching with each other one to one.

That is, one light source 10 and one reflector 40 compose one pair, and the light output from any one light source 10 is reflected toward the light emitting section 30 only through the reflector 40 making a pair with the light source 10.

The center of the incident plane of the light emitting section 30 and the focal point of all reflectors 40 coincide, that is, the light of the light sources 10 reflected through all reflectors 40 is all collected to the center of the incident plane of the light emitting section 30, so that the amount of the light may be secured to the maximum as far as possible.

As the condition in which the center of the incident plane of the light emitting section 30 and the focal point of all reflectors 40 coincide, as shown in FIG. 6A, FIG. 6B, and FIG. 7, each reflector 40 forms an ellipse M1 having as the focal points the center F1 of the projecting plane of the light source 10 which matches with the relevant reflector 40 and the center F2 of the incident plane of the light emitting section 30, and forms a regular circle M2 about the axis L1 passing through the centers F1 and F2.

The surface of the reflector 40 is deposited with aluminum superior in the reflection performance or treated with the silver reflection coating to increase the reflection efficiency.

However, the silver reflection film may be used when necessary.

The housing 50 comprises a lower cover 51 in which the upper side is opened and the interior bottom side is the reflector 40, and an upper cover 52 which is connected to the lower cover 51 so as to seal the upper opening section of the lower cover, to interior side of which the PCB 20 is connected so that the light sources 10 is facing the reflector 40, to which the light emitting section 30 is connected, and at the exterior side of which the heat sink 60 is formed.

Since the inside of the lower cover 51 is sealed by the combination of the upper cover 52, the leakage of the light may be prevented so as to maximize the light efficiency.

The present invention may further comprise a light collecting lens 70 when necessary.

The light collecting lens 70 is fixed to the lower cover 51 so as to be placed one at the front side of each light source 10, so as to give aid in securing the amount of light by collecting the light projected from the light sources 10.

However, in the present invention, since the light sources 10, the light emitting section 30, and the reflectors 40 are all provided in the housing 50 so as to remove the leak of the light and the loss of the light to the maximum as far as possible to maximize the securing of the amount of light, if the effect of additional securing of the amount of light in comparison to the rise of cost according to the use of the light collecting lens 70 is not large, the light collecting lens 70 may not be used to save the cost.

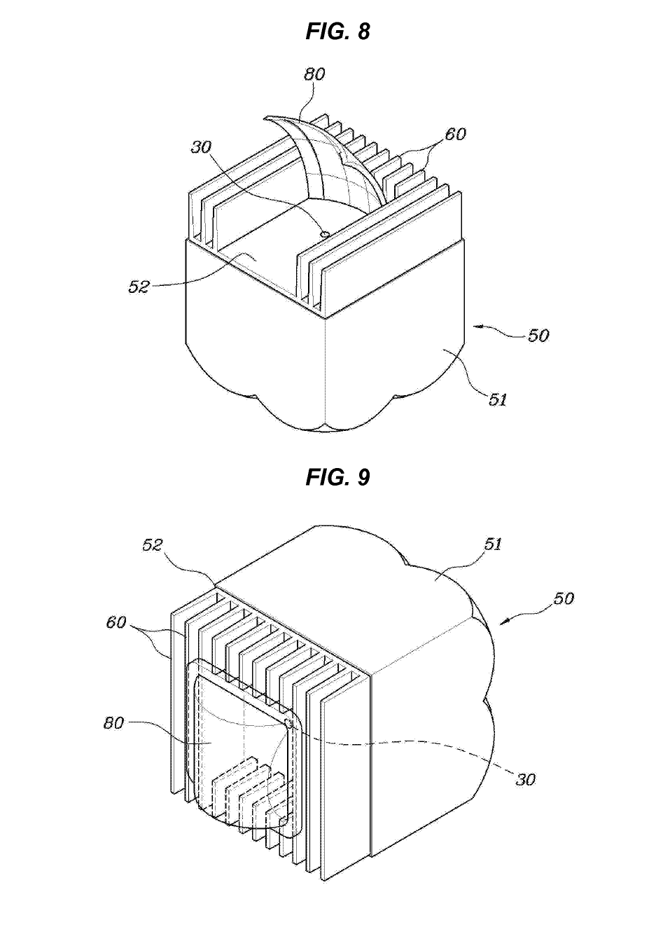

Furthermore, the present invention may further comprise an auxiliary reflector 80 which is connected to the outside surface of the upper cover 52 so as to be placed at the outside of the housing 50 and reflects the white light projected through the light emitting section 30 to a required direction, and when the auxiliary reflector 80 is used, it may be a parabolic reflection surface having as the focal points the center of the projection surface of the light emitting section 80 as shown in FIG. 8 or the rectangular projector as shown in FIG. 9.

As described above, various embodiments of the present invention have an advantage in that the light from the plurality of light sources 10 is collected and output by one light emitting section 30 so as to be able to secure a large amount of light through the increase of the light, thereby significantly increasing the light efficiency.

Furthermore, the light sources 10, the light emitting section 30, and the reflectors 40 are all provided in the housing 50, and in particular, the light output from the light sources 10 is not transmitted by using the light guide section (optical fiber) which is a conventional light transmitting medium, but is reflected toward the light emitting section 30 by the reflectors 40 in the housing 50, thereby achieving the reduction in cost and weight and reducing the entire size of the optical system.

In addition, since a conventionally separate aspheric lens (light collection lens) is not used to collect the light output from the light sources 10, there is the advantage in that the saving of the cost and the reduction of the weight may be sought.

Furthermore, since the heat from the plurality of light sources 10 and the light emitting section 30 is radiated by using one heat sink 60, there is the advantage in that the cost may be reduced and the size of the optical system may be reduced through the reduction of the layout.

In addition, since the one light emitting section 30 is placed at the center of the plurality of light sources 10, there is the advantage in that the largest amount of light as far as possible may be secured.

Furthermore, since the center of the incident surface of the light emitting section 30 and the focal points of all reflectors 40 coincide, that is, the light of the light sources 10 reflected through all the reflectors 40 is all collected to the center of the incident surface of the light emitting section 30, there is the advantage in that the largest amount of light as far as possible may be secured.

According to the present invention, the light from the plurality of light sources is collected by one light emitting section so as to increase the light efficiency by increasing the amount of light, and the light sources, the light emitting section, and the reflectors are all provided in the housing, and the light output from the light sources is reflected toward the light emitting section by the reflectors in the housing, thereby achieving the reduction in cost and weight and reducing the entire size of the optical system may be reduced.

Furthermore, according to the present invention, the heat from the plurality of light sources and the light emitting section is radiated by using one heat sink, so that there is advantage in that the cost may be reduced, the size of the optical system may be reduced through the reduction of the layout.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A laser optical system for a vehicle lamp comprising:
a plurality of light sources for generating laser beams;
a Printed Circuit Board (PCB) which is fixed and connected to the light sources and configured to control supply of current to the light sources;
a light emitting section configured for acting with light output from the light sources and outputting white light;
a plurality of reflectors configured for reflecting the light output from the light sources to the light emitting section; and
a housing to which the PCB and the light emitting section are fixed and connected,
wherein the light sources and the light emitting section are connected to the housing and a laser beam projecting direction and a white light projecting direction are opposite to each other, and
wherein an interior side of the housing facing the laser beam projecting direction is the reflectors.

2. The laser optical system for the vehicle lamp of claim 1, further comprising a heat sink radiating heat generated at the light sources and the light emitting section to an outside.

3. The laser optical system for the vehicle lamp of claim 2, wherein the heat sink is one in number, and
heat from the plurality of light sources and the light emitting section is radiated by the heat sink.

4. The laser optical system for the vehicle lamp of claim 1, wherein the light emitting section is one in number, and
the light emitting section is placed at a center of the plurality of light sources.

5. The laser optical system for the vehicle lamp of claim 4, wherein the plurality of light sources are arranged with equal spacing along a circumferential direction in which the light emitting section is in the center, to be arranged cross to each other about the light emitting section.

6. The laser optical system for the vehicle lamp of claim 4, wherein the plurality of reflectors are equal in number to the light sources, and
the light sources and the reflectors match with each other one to one.

7. The laser optical system for the vehicle lamp of claim 6, wherein a center of an incident plane of the light emitting section and a focal point of the reflectors coincide.

8. The laser optical system for the vehicle lamp of claim 6, wherein each reflector forms an ellipse having as focal points a center of a projecting plane of the light source which matches with a corresponding reflector and a center of an incident plane of the light emitting section, and forms a regular circle about an axis passing through the centers.

9. The laser optical system for the vehicle lamp of claim 2, wherein a surface of each reflector is deposited with aluminum superior in reflection performance or treated with silver reflection coating to increase reflection efficiency.

10. The laser optical system for the vehicle lamp of claim 2, wherein the housing comprises:
a lower cover in which an upper side thereof is open and an interior bottom side is the reflector; and
an upper cover, which is connected to the lower cover to seal the opened upper side of the lower cover, the PCB being connected to an interior side of the upper cover so that the light sources face the reflectors, the light emitting section being connected to the upper cover, and the heat sink being formed at an exterior side of the upper cover.

11. The laser optical system for the vehicle lamp of claim 10, further comprising a light collecting lens which is fixed to the lower cover to be placed at a front side of each light source, to collect light projected from the light sources.

12. The laser optical system for the vehicle lamp of claim 10, further comprising an auxiliary reflector which is connected to an outside surface of the upper cover to be placed at an outside of the housing and reflects back the white light projected through the light emitting section to a required direction.

13. The laser optical system for the vehicle lamp of claim 12, wherein the auxiliary reflector is a parabolic reflection surface having as a focal point a center of a projection surface of the light emitting section or a rectangular projector.
